(19) United States
(12) Patent Application Publication
(10) Pub. No.: US 2025/0251558 A1
(43) Pub. Date: Aug. 7, 2025

(54) WAVEGUIDE LIGHT-EMITTING AND SENSING MODULES

(71) Applicant: COHERENT PHOTONICS LLC, Plainsboro, NJ (US)

(72) Inventors: Michael Soskind, Plainsboro, NJ (US); Yakov Soskind, Plainsboro, NJ (US)

(21) Appl. No.: 19/094,413

(22) Filed: Mar. 28, 2025

Related U.S. Application Data
(63) Continuation-in-part of application No. 18/657,457, filed on May 7, 2024.
Application No. 18/657,457 is a continuation-in-part of application No. 18/144,304, filed on May 8, 2023, now Pat. No. 12,294,788.

(51) Int. Cl. G02B 6/42; G01J 1/04; G01J 1/42

(52) U.S. Cl. CPC G02B 6/4298; G01J 1/0411; G01J 1/0425; G01J 1/4228

(57) ABSTRACT

Waveguide-based light-emitting and sensing modules containing arrays of diffractive regions for applications requiring sensing spatially localized regions are described. Waveguide-based light-emitting modules can produce a variety of patterns illuminating the spatially localized regions, including continuously illuminated regions, periodic arrays of spots, circular-symmetric and randomized structured patterns. Waveguide-based sensing modules will receive light from the spatially localized regions. Waveguide-based light-emitting and sensing modules can be integrated on the same waveguiding substrate, resulting in compact sensing solutions. Applications of the waveguide-based modules include biometric identification, eye-tracking for smart eyewear and miniaturized solutions for medical diagnostics, such as endoscopy.

### BACKGROUND TO RELATED APPLICATION

This application is a continuation-in-part of U.S. Ser. No. 18/657,457, filed May 7, 2024 entitled WAVEGUIDE LIGHT EMITTING MODULE, which is a continuation-in-part of U.S. Ser. No. 18/144,304, filed May 8, 2023 entitled WAVEGUIDE-BASED LIGHT FIELD CAMERA, the contents of which are incorporated herein by reference.

### FIELD OF THE INVENTION

The present invention relates to the field of sensors that produce spatial light distributions and sense light reflected or scattered from the regions of interest. More specifically, the invention relates to waveguide-based light-emitting and sensing modules containing arrays of diffractive regions to illuminate or sense spatially localized regions.

### BACKGROUND OF THE INVENTION

Conventional light emitting modules that produce spatial light distributions are composed of light emitting sources and an assembly of optical components, such as lenses, mirrors, or their combinations. Edge-emitting lasers, vertical cavity surface emitting lasers (VCSELs) or light-emitting diodes (LEDs) are examples of light emitting devices. Individual light emitters and assemblies of light emitters can be used within the light emitting modules to produce a variety of illumination patterns. Light emitting modules can be designed to produce either diffuse or structured light distributions and are employed in a variety of sensing systems. Traditional light emitting modules are relatively bulky, making them challenging to integrate into sensor systems with strict weight and spatial constraints.

Conventional sensors are based on imaging principles, when objects located within the sensor field of regard are imaged onto an array of photosensitive pixels. Light field sensors, also referred to as plenoptic sensors, represent an alternative approach to conventional image-forming sensors. Instead of forming images of objects on the photosensitive area, light field sensors detect directions and intensity of the incident light representing angular information. Light field sensors are employed in place of imaging sensors when the presence of objects and their spatial location within the field of regard are more important than detailed shapes of these objects. Light field cameras commonly consist of an assembly composed of several optical components, such as lenses and mirrors. A micro-lens array can be placed between the optical components and the pixelated photosensitive area. As a result, conventional sensors are relatively bulky, often not suitable for sensor systems with weight and size restrictions.

### SUMMARY OF THE INVENTION

In view of the foregoing, one object of the present invention is to provide light emitting and sensing modules with reduced size and weight for sensing spatially localized regions.

Another object of the present invention is to provide light emitting and sensing modules for sensing spatially localized regions that can be fabricated in a cost-effective and scalable manner.

Still another object of the present invention is to provide light emitting and sensing modules that can be integrated into a single and compact sensor assembly.

To achieve the desired goals, the light emitting and sensing modules employ waveguiding components containing arrays of diffractive phase regions. Employing the waveguiding structures allows for designing light emitting and sensing modules with reduced size and weight when compared with conventional light emitting and sensing modules employing traditional optical components with refractive and/or reflective surfaces.

Waveguiding components can be comprised of a plane-parallel plate made of optically transparent material, and usually contain light in-coupling regions where the light enters the waveguide, waveguiding regions where the in-coupled light experiences waveguiding propagation within the plate, and out-coupling regions where the waveguided light exits the waveguiding component. To further reduce the overall size and improve manufacturability, the in-coupling and the out-coupling regions are often made as diffractive structures. Different types of diffractive structures can be employed within the in-coupling and out-coupling regions, such as linear gratings, 2D or 3D meta-surfaces containing sub-wavelength surface-relief structures, or holographic structures composed of localized sub-wavelength refractive index modulations. Meta-surfaces can be comprised of individual subwavelength structures, such as posts or holes, as well as free-form shaped regions. The in-coupling and the out-coupling diffractive regions can be also made transmissive or reflective.

To achieve the waveguided propagation of the in-coupled fields within the waveguiding component, the angles of the in-coupled light within the plane-parallel plate should exceed the critical angle at the waveguide planar interfaces, resulting in the formation of evanescent orders. In addition, angles of the diffracted in-coupled light fields need to satisfy the propagation condition for the working diffraction order (see for example Y. Soskind, “Field Guide to Diffractive Optics”, SPIE Press, 2011, page 51). Therefore, the waveguided propagation can be expressed as:

$$\frac{1}{{n}_{s}} < \vert \frac{1}{{n}_{s}} ( sin ( {θ}_{i} ) + \frac{λ}{{d}_{g}} ) \vert < 1 \qquad ( 1 )$$

where θᵢ is the incident angle of light, λ is the light wavelength, d_{g} is the grating's periodicity, and nₛ is the waveguiding component substrate's refractive index. It is also assumed in equation (1) that the order of diffraction is m=1, and the index of refraction in air is n_{Air}≈1. The light emitting and sensing waveguiding modules with diffractive phase regions can be employed in a variety of applications, such as smart eyewear, endoscopy and smartphones. For example, they can be made as an integral part of the eyewear lenses, providing compact eye-tracking solutions with reduced parallax. Compact size of the light emitting and sensing waveguiding modules makes them suitable for integration into optical heads of endoscopes and into smartphones as behind the screen illumination and imaging solutions.

Objectives of the present invention are achieved in accordance with the following implementation techniques and design examples, as will be explained in detail in the following illustrative embodiments.

The features of the present invention, including the construction and operational details of the illustrative embodiments, will be described in reference to the accompanying drawings.

### BRIEF DESCRIPTION OF THE DRAWINGS

FIG. 1 presents a side view of the waveguide-based module in accordance with the present invention.

FIG. 2 presents a side view of light from an assembly of light emitters collimated by a diffractive flat lens or light collected by a diffractive flat onto a pixelated array of sensors.

FIG. 3 shows a close-up view of the light emitted by the individual sources or collected onto individual sensors.

FIG. 4 presents a top view of the waveguiding component in accordance with the present invention.

FIG. 5 shows the three-dimensional geometry defining diffraction of the waveguided light by the individual gratings' sub-regions.

FIG. 6 shows the top view geometry defining the waveguiding component containing one of the individual diffractive sub-regions and the common diffractive region.

FIG. 7 presents a first layout of the diffractive sub-regions.

FIG. 8 presents a second layout of the diffractive sub-regions.

FIG. 9 presents a third layout of the diffractive sub-regions.

FIG. 10 presents the spatial phase distribution of a diffractive lens centered over the common diffractive region.

FIG. 11 presents the spatial phase distribution of a diffractive grating.

FIG. 12 presents the spatial phase distribution of a diffractive lens offset from the center of the common diffractive region.

FIG. 13 presents the spatial phase distribution of a second diffractive grating.

FIG. 14 presents the spatial phase distribution of a diffractive lens with different offset from the center of the common diffractive region.

FIG. 15 shows a side view of the waveguide-based module in accordance with the first example.

FIG. 16 shows a side view of the waveguide-based module in accordance with the second example.

FIG. 17 presents a side view of an alternative waveguide-based module in accordance with the present invention.

FIG. 18 presents a side view of an alternative waveguide-based module in accordance with the present invention.

FIG. 19 presents a side view of an alternative waveguide-based module in accordance with the present invention.

FIG. 20 presents a side view of light propagating at an angle through a diffractive flat lens.

FIG. 21 presents a side view of an alternative waveguide-based module in accordance with the present invention.

FIG. 22 presents a side view of an alternative waveguide-based module in accordance with the present invention.

FIG. 23 presents a side view of an alternative waveguide-based module in accordance with the present invention.

FIG. 24 presents a side view of an alternative waveguide-based module containing means for laterally shifting the light emitter assembly or sensor array with respect to the diffractive flat lens.

FIG. 25 presents a side view of an alternative waveguide-based module containing means for laterally and axially shifting the light emitter assembly or sensor array with respect to the diffractive flat lens.

FIG. 26 present a side view of an alternative waveguide-based module in accordance with the present invention.

FIG. 27 presents a top view of a waveguiding component contained within the module in FIG. 26.

FIG. 28 present a side view of an alternative waveguide-based module in accordance with the present invention.

FIG. 29 present a side view of the waveguide-based module in FIG. 28 with the light-emitting assembly or sensing array shifted in positive Y-axis direction.

FIG. 30 present a side view of an alternative waveguide-based module in FIG. 28 with the light-emitting assembly or sensing array shifted in negative Y-axis direction.

FIG. 31 present a side view of an alternative waveguide-based module in accordance with the present invention.

FIG. 32 presents a top view of a waveguiding component contained within the module in FIG. 31.

FIG. 33 presents a side view of an alternative waveguide-based module in accordance with the present invention.

FIG. 34 presents a side view of an alternative waveguide-based module in accordance with the present invention.

FIG. 35 presents a side view of an enlarged fragment of the pixelated display in FIG. 34.

FIG. 36 presents a side view of an alternative waveguide-based module in accordance with the present invention.

### DETAILED DESCRIPTION

The present invention is further described in detail in the form of the specific embodiments. However, the present invention is not limited to only the specific embodiments described herein, and can be employed with a broad range of modifications to the disclosed embodiments. For example, assemblies of emitters and individual emitters can be employed as sources within the light emitting modules of the present invention. Emitter assemblies can employ different types of emitters, with different spectral compositions, spacings and sizes. Emitter assemblies can be also based on periodic arrays of identical sources. Assemblies of individual photodetectors, periodic arrays of photodetectors and individual photodetectors can be employed as photosensitive regions within the light sensing modules of the present invention. The waveguide-based light emitting modules of the present invention can be used to produce either structured or homogeneously distributed illumination patterns. The waveguide-based light sensing modules of the present invention can be used to form images of objects or to sense directionality of the incident light. While in the following embodiments the in-coupled light is directed in a single direction, the in-coupling regions can be designed to split the light into several in-coupled directions that will experience wave-guiding propagation. The out-coupling regions can be also designed to split the out-coupled light into several out-coupled directions.

While the following description is applied to light emitting waveguiding modules, it is understood by those skilled in the art that by reversing the light propagation directions through the waveguiding modules this invention will also apply to light sensing modules containing waveguiding components. FIG. 1 presents a side view of the light emitting waveguiding module perpendicular to the waveguide propagation direction in accordance with the present invention. The light emitting module 100 contains an assembly of emitters 101, a planar lens 102, and a waveguiding component 103 with planar interfaces defined by surfaces 107 and 108. The lens 102 and the waveguiding component 103 are placed in proximity to each other. The waveguiding component contains an in-coupling region 109 and an out-coupling region 110 fabricated onto the surface 107. The in-coupling region 109 and the out-coupling region 110 can incorporate different diffractive structures, such as meta-surfaces, geometrical phase surfaces, volume holograms, multi-step binary surfaces, etc. The diffractive structures can be made transmissive or reflective, and can be fabricated using a variety of techniques, such as projection lithography, nano-imprint, holographic recording, etc. FIG. 1 also shows the waveguided light 105 within component 103, and the output light beams 104 emitted in multiple directions from the out-coupling region 110 of the waveguiding component 103.

The light from emitter assembly 101 is directed onto a flat diffractive lens 102 that collimates the emitted light 106 and directs it towards the waveguide in-coupling region 109. Collimated beams from the individual emitters are incident onto the in-coupling structure 109 at different angles. The angular difference Δφ between the incident collimated beams depends on the lateral spacing d between the emitters within the assembly and the focal length f of the lens 102, and can be estimated as:

$$Δφ = {tan}^{- 1} ( \frac{d}{f} ) \qquad ( 2 )$$

The collimated light in-coupled into the waveguiding component 103 through the transmissive diffractive in-coupling region 109 at angles exceeding the critical angle of total internal reflection (TIR) is converted into waveguided modes 105 that travel within the waveguiding component 103 while experiencing TIR at planar interfaces 107 and 108. As the waveguided light 105 reaches the out-coupling region 110, it is extracted from the waveguide and directed by different sub-regions of the out-coupling region 110 in different output directions 104.

FIG. 1 shows an example of the waveguided light experiencing 9 instances of TIR on the planar interfaces of the waveguiding component prior to reaching the out-coupling region 110. The number of TIRs within the waveguiding component can differ and will depend on the desired distance between the in-coupling and out-coupling regions, in addition to the diffraction angles and the waveguide thickness. When the in-coupling and out-coupling regions are located on the same side of the waveguide, then the number of TIRs within the waveguiding component experienced by the propagating light prior to reaching the out-coupling region will be odd. When the in-coupling and out-coupling regions are located on opposite sides of the waveguiding component, then the number of TIRs within the waveguide experienced by the propagating light prior to reaching the out-coupling region will be even. After reaching the out-coupling region 110, the waveguided light is outcoupled from the waveguiding component 103 at different angles, as shown by different directions of output light beams 104.

The in-coupling region 109 serves as the entrance aperture of the waveguiding component 103, and is comprised of diffractive structures. The in-coupled light 105 is directed onto the out-coupling region 110, where it is diffracted out of the waveguide by individual sub-regions of the out-coupling structure 110. The out-coupling region 110 serves as the exit aperture of the emitting module and is comprised of multiple out-coupling sub-regions with different transmissive diffractive properties that diffract output light in different directions of output light beams 104. The individual sub-regions of the structure 110 out-couple incident light to the specific angular directions defined by the diffractive properties of the specific sub-regions.

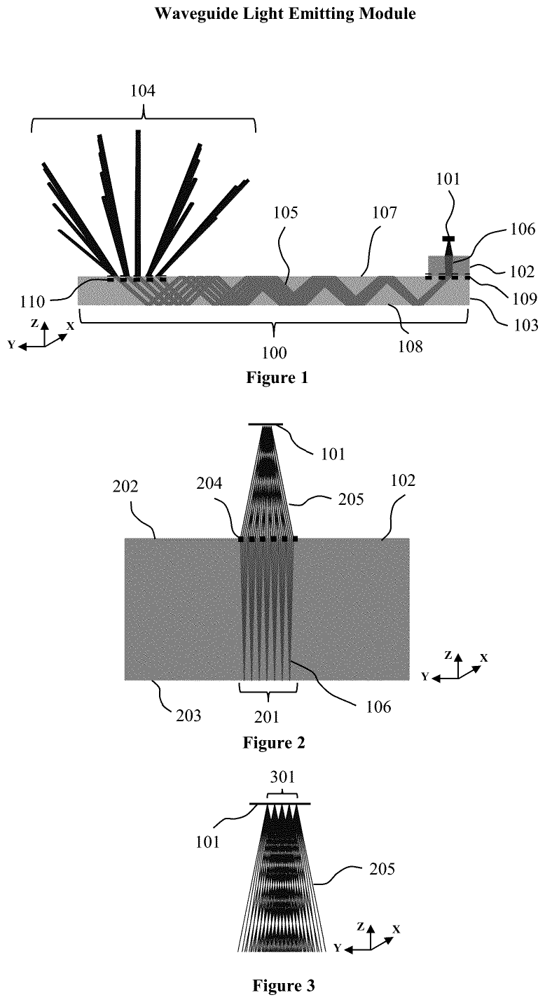

FIG. 2 shows light propagation from an assembly of emitters 101 first introduced in FIG. 1 through the flat lens 102 onto the lens exit aperture 201. The lens 102, also first introduced in FIG. 1, consists of a block of an optical material transparent within the spectral region of the waveguide-based light emitting module, such as optical glass, silicon, or fused silica. The lens 102 has two plane parallel optical surfaces 202 and 203. Alternative lens designs may contain diffractive regions fabricated on both lens surfaces 202 and 203, or solely on one of the lens surfaces. Lens 102 shown in FIG. 2 has a single diffractive structure 204 placed on surface 202 facing the emitter assembly 101. Emitted diverging light 205 from the assembly of emitters 101 is collimated by the diffractive structure 204. The collimated light 106 is directed onto the lens exit aperture 201 located on lens surface 203. Diffractive region 204 can be made as a diffractive phase structure, such as a meta-surface, geometrical phase surface, volume hologram, multi-step binary surface, etc.

Lenses with planar interfaces are well suited for integration with waveguiding components having planar surfaces. The lens optical power is produced by diffractive regions fabricated either on one or both planar surfaces of the lens. Diffractive regions of the planar lens can be comprised of different types of structures, including surface relief or encapsulated diffractive stair-case or blazed structures, surface relief or encapsulated sub-wavelength meta-optics structures, or volume Bragg gratings and holograms comprised of localized sub-wavelength refractive index modulations of the optical medium. It should be noted that lens components with at least one non-planar optical interface, such as spherical or aspherical refractive surface, can also be used to direct emitted light onto the in-coupling region of the waveguide.

FIG. 3 presents an enlarged view of the divergent light 205 emitted from the individual emitters 301 composing the emitter assembly 101. The emitted divergent light 205 is directed towards the diffractive collimating lens.

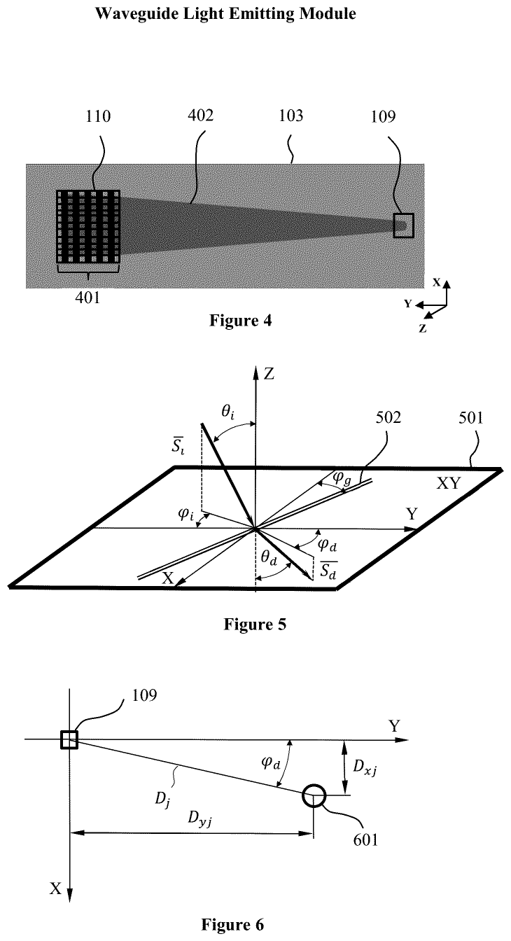

FIG. 4 presents a top view of the waveguiding component 103 containing the in-coupling region 109 and the out-coupling region 110, first introduced in FIG. 1. While the in-coupling region 109 is shown as having a square-shaped outline, it can also be made as a polygonal structure of different shape, as a circle, or as an ellipse. To achieve efficient in-coupling, the size of the in-coupling region 109 is made at least the size of the output aperture the planar lens. The out-coupling region 110 is composed of smaller subregions with different diffractive properties. The individual sub-regions can be made of different shapes and sizes. The sub-regions can be arranged within the out-coupling region in a randomized, irregular manner, or as arrays of sub-regions arranged in rows or columns, where the rows and columns can be placed next to each other or separated with spaces. Individual sub-regions contain diffractive structures with different optical properties, such as gratings, lenses, beam-splitters, and their combinations. The out-coupling subregions of the out-coupling region 110 are shown schematically as vertical columns 401. FIG. 4 also shows the footprint of the waveguided light 402 within the waveguiding component 103 as it propagates from the in-coupling region 109 to the out-coupling region 110.

Designs of the gratings within the in-coupling region and the diffractive structures within the individual out-coupling sub-regions are based on their diffractive properties that depend on their phase distributions. The phase distributions are defined by pitch and azimuthal orientation of the grating ridges or spatial arrangements of sub-wavelength structures, including their shapes and sizes. The phase distributions need to take into account several parameters, including direction of the incident light, diffraction of the incident light on the in-coupling grating structures into the waveguide, propagation direction and number of TIR interactions of the in-coupled light prior to reaching the out-coupling sub-regions, and diffraction of the waveguided light on the individual out-coupling sub-regions with different shapes, sizes and diffraction phase distributions.

FIG. 5 schematically shows the three-dimensional geometry defining diffraction of light on the transmissive diffractive structure with boundary 501 representing the in-coupling region of the waveguiding structure. FIG. 5 shows light incident onto the transmissive diffractive structure from a medium with lower refractive index nᵢ, such as air, into a denser medium with higher refractive index n_{d}, such as glass, representative of in-coupling into the waveguide through the in-coupling grating of the in-coupling region. In that case nᵢ<n_{d}, and the incident angle θᵢ is smaller than the in-coupled diffracted angle θ_{d}, i.e. θᵢ<θ_{d}. Geometry definition in FIG. 5 is also applicable to define out-coupling of the waveguided light from one of the out-coupling sub-regions. For the out-coupling of the waveguided light from the out-coupling sub-regions, the light incident onto the transmissive diffractive sub-region will be travelling from the denser medium with higher refractive index nᵢ, such as glass, into a medium with lower refractive index, such as air n_{d}, i.e. nᵢ>n_{d}. And the incident angle θᵢ within the waveguide will be larger than the out-coupled angle θ_{d} into the air, i.e. θᵢ>θ_{d}.

Propagation directions of the incident light and the diffracted light are defined by respective unit vectors S̅_̅{̅ι̅}̅ and S̅_̅{̅d̅}̅ in the Cartesian coordinate system. In the case of FIG. 5, the unit vectors are oriented in the case of in-coupling with refractive index relation nᵢ<n_{d}. The X- and Y-axes define a plane XY, schematically shown as a dashed area, that contains the in-coupling region. The grating lines 502 in FIG. 5 are oriented at an angle φ_{g} with respect to the X-axis of the coordinate system.

The unit vector S̅_̅{̅ι̅}̅ is composed of three directional components Sᵢₓ, S_{iy}, and S_{iz} along the respective X-axis, Y-axis and Z-axis unit vectors ι̅, [symbol] , and k̅:

$$\overline{{S}_{ι}} = {S}_{ix} \overline{ι} + {S}_{iy} \overline{J} + {S}_{iz} \overline{k} \qquad ( 3 )$$

The individual components of the unit vector S̅_̅{̅ι̅}̅ are functions of the azimuth φᵢ and elevation θᵢ angles shown in FIG. 5:

$${S}_{ix} = sin ( {θ}_{i} ) sin ( {φ}_{i} ) \qquad ( 4 )$$

$${S}_{iy} = sin ( {θ}_{i} ) cos ( {φ}_{i} ) \qquad ( 5 )$$

$${S}_{i z} = cos ( {θ}_{i} ) \qquad ( 6 )$$

Direction of the in-coupled light diffracted by the grating is defined by a unit vector S̅_̅{̅d̅}̅:

$$\overline{{S}_{d}} = {S}_{dx} \overline{ι} + {S}_{dy} \overline{J} + {S}_{dz} \overline{k} \qquad ( 7 )$$

The individual components of the unit vector S̅_̅{̅d̅}̅ are functions of the diffracted azimuth φ_{d} and elevation θ_{d} angles:

$${S}_{dx} = sin ( {θ}_{d} ) sin ( {φ}_{d} ) \qquad ( 8 )$$

$${S}_{dy} = sin ( {θ}_{d} ) cos ( {φ}_{d} ) \qquad ( 9 )$$

$${S}_{dz} = cos ( {θ}_{d} ) \qquad ( 10 )$$

By definition, components of the unit vectors S̅_̅{̅ι̅}̅ and S̅_̅{̅d̅}̅ satisfy the following equations:

$${( {S}_{ix} )}^{2} + {( {S}_{iy} )}^{2} + {( {S}_{iz} )}^{2} = 1 \qquad ( 11 )$$

$${( {S}_{dx} )}^{2} + {( {S}_{dy} )}^{2} + {( {S}_{dz} )}^{2} = 1 \qquad ( 12 )$$

Components of the in-coupled unit vector can be found based on the following two equations that account for diffraction on the in-coupling grating structure, where n is the refractive index of the waveguide material:

$${n}_{d} sin ( {θ}_{d} ) sin ( {φ}_{d} ) = {n}_{d} sin ( {θ}_{i} ) sin ( {φ}_{i} + {φ}_{g} ) \qquad ( 13 )$$

$${n}_{d} sin ( {θ}_{d} ) cos ( {φ}_{d} ) = {n}_{i} sin ( {θ}_{i} ) cos ( {φ}_{i} + {φ}_{g} ) + \frac{m λ}{{d}_{j}} \qquad ( 14 )$$

Parameter m in equation (14) denotes the order of diffraction, λ is the wavelength of the incident light, and dⱼ is the periodicity of the grating structure of the j-th in-coupling region. In many cases, the gratings are designed to work in the first order of diffraction, so that m=1.

The relative positions of the individual out-coupling sub-regions of the waveguiding component are designed to intercept the light from selected emitters of the emitter assembly. The individual out-coupling sub-regions subsequently diffract the intercepted light into selected angular directions. The size and location of an individual sub-region can be chosen so that it intercepts at least a fraction of light from a particular light emitter. Diffraction properties of the individual out-coupling sub-regions are defined to out-couple at least a fraction of the light intercepted by the individual out-coupling sub-region.

FIG. 6 schematically shows the top view of the waveguiding component containing an in-coupling region 109 and one of the out-coupling sub-regions denoted by an integer j and having boundary 601. Following diffraction on the grating structure, the in-coupled light travels a distance Dⱼ along the waveguiding component from the in-coupling region to the center of the out-coupling sub-region. The specific distances between the in-coupling region and the individual out-coupling sub-regions of the waveguide depend on their respective locations within the out-coupling region, diffractive properties of the in-coupling region, the waveguide thickness, and the number of TIRs experienced by the in-coupled light prior to reaching the specific out-coupling sub-region. When the in-coupling region and the out-coupling sub-regions are located on the same surface of the waveguiding component, the in-coupled light will undergo an odd integer number of TIRs prior to reaching the out-coupling region. When the in-coupling region and the out-coupling sub-regions are located on opposite surfaces of the waveguide, the in-coupled light will undergo an even number of TIRs. These conditions impose additional constraints on the orientations and periodicities of the gratings within the specific out-coupling sub-regions. FIG. 6 illustrates the geometrical relations between an in-coupling region 109, schematically shown as a square, and a circular-shaped out-coupling sub-region 601, schematically shown as a circle. The in-coupling region 109 is connected to the out-coupling sub-region 601 by a line Dⱼ representing the distance between the two regions along the waveguide surface parallel to the XY plane. FIG. 6 also shows the respective X-axis and Y-axis lateral distances Dₓⱼ and D_{yj} between the centers of the in-coupling region and the out-coupling sub-region. The distance Dⱼ can be found as:

$${D}_{j} = \sqrt{{( {D}_{xj} )}^{2} + {( {D}_{yj} )}^{2}} \qquad ( 15 )$$

Following diffraction on the in-coupling grating structure, the in-coupled light will propagate towards the center of the out-coupling sub-region within a plane defined by the direction of the in-coupled light S̅_̅{̅d̅}̅ and the normal to the waveguide surface defined by the Z-axis vector k̅. The in-coupled light will encounter multiple TIRs.

Between each consecutive TIR, the in-coupled light will advance towards the center of the out-coupling region by an incremental distance ΔDⱼ:

$$Δ {D}_{j} = \frac{T}{tan ( {θ}_{dj} )} \qquad ( 16 )$$

where T is the waveguide thickness, defined as the distance between the planar interfaces of the waveguiding component, and θ_{dj} is the elevation angle of the light field after diffraction on the j-th out-coupling sub-region.

The distance Dⱼ contains an integer number N of TIR steps during propagation:

$${D}_{j} = N Δ {D}_{j} \qquad ( 17 )$$

For a given direction of the incident light S̅_̅{̅ι̅}̅, the distance Dⱼ between the in-coupling region and the out-coupling sub-region, thickness T and refractive index n of the waveguide, operating wavelength λ, and required number of TIRs within the waveguide N, the equations (3) through (17) can be numerically solved to yield the nominal periodicities dⱼ of the out-coupling gratings and their azimuthal orientations φ_{g}.

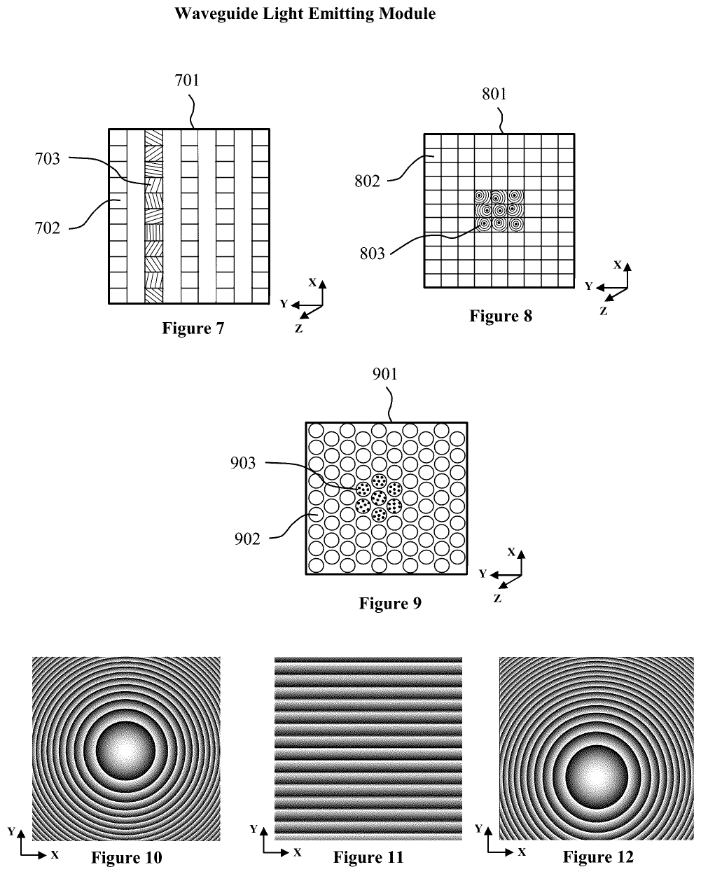

FIGS. 7 through 9 present different layouts of the out-coupling regions of the waveguiding component. The out-coupling regions are composed of several out-coupling sub-regions of different shapes and sizes, such as circles, hexagons, triangles, and their combinations. While the out-coupling regions in FIGS. 7 through 9 may contain a large number of sub-regions, only a limited number of the sub-regions is shown in FIGS. 7 through 9 for clarity. Each sub-region may contain different diffractive structures, such as gratings, lenses, and their combinations.

FIG. 7 presents a schematic layout of the out-coupling region 701 of the waveguiding component containing multiple rectangular-shaped diffractive sub-regions 702. The out-coupling sub-regions 702 arranged in columns with separation gaps between the columns. The out-coupling sub-regions 702 in FIG. 7 are composed of different diffractive gratings 703. Diffraction gratings 703 within the individual out-coupling sub-regions 702 have different periodicities and different azimuthal orientations of the gratings' lines. Only a limited number of gratings 703 is shown in FIG. 7 for clarity.

FIG. 8 presents a schematic layout of the out-coupling region 801 containing several rectangular-shaped out-coupling sub-regions 802 arranged in a two-dimensional array of rows and columns. The out-coupling sub-regions 802 in FIG. 8 are composed of different diffractive lenses 803. Diffractive lenses 803 within the individual out-coupling sub-regions 802 may have different focal lengths and lateral offsets. Only a limited number of lenses 803 is shown in FIG. 8 for clarity.

FIG. 9 presents a schematic layout of the out-coupling region 901 containing several circular-shaped out-coupling sub-regions 902 arranged in a two-dimensional array, for which every other column of the out-coupling sub-regions is vertically offset by half the vertical spacing between the sub-regions. The out-coupling sub-regions 902 in FIG. 9 are composed of arrangements of sub-wavelength structures 903, also known as meta-atoms, such as pillars, holes or fins with different sizes, azimuthal orientations, and shapes. The nano-structure arrangements 903 within the individual out-coupling sub-regions 902 form different gratings, lenses, beam-splitters, and their combinations. Only a limited number of nano-structures 903 is shown in FIG. 9 for clarity. Other shapes such as rectangles, hexagons, etc. can also be tiled for use as out-coupling regions.

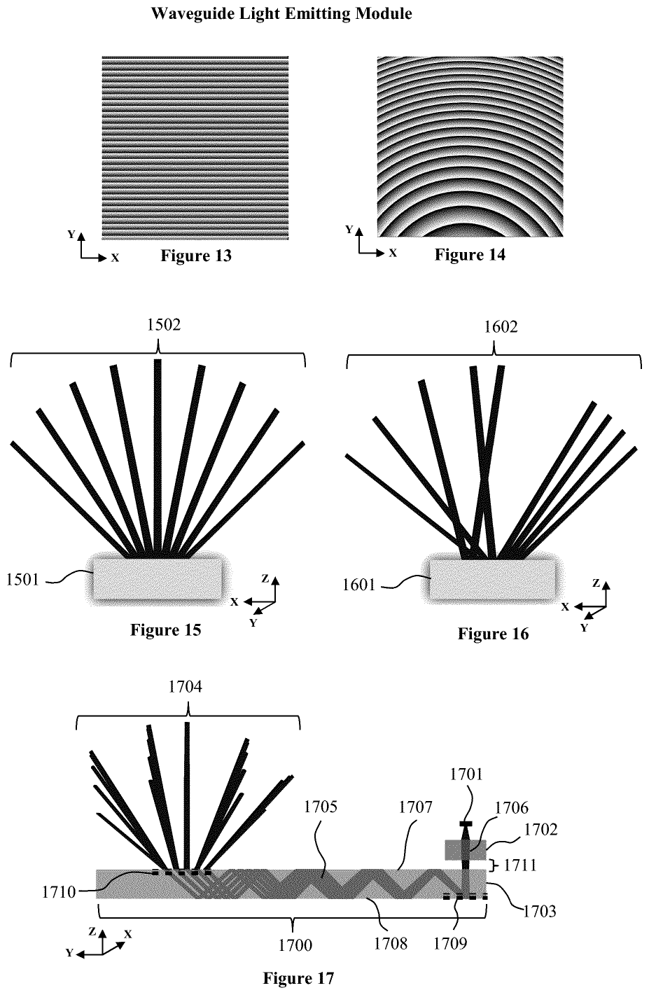

FIG. 10 presents the spatial phase distribution of a diffractive lens with square aperture centered to the square-shaped out-coupling sub-region. FIG. 11 schematically presents the spatial phase distribution of a diffraction grating with square aperture located within the square-shaped out-coupling sub-region. The phase gradient of the grating in FIG. 11 is along the direction of the grating's periods. The lens and grating functions can be combined in a single diffractive structure, resulting in a diffractive lens phase distribution that is offset from the out-coupling sub-region center, as shown in FIG. 12. FIG. 13 presents the spatial phase distribution of another diffraction grating placed within the square-shaped out-coupling sub-region. The phase gradient of the grating in FIG. 13 is along the direction of the grating's periods. The grating in FIG. 13 has a smaller grating periodicity as compared with the grating in FIG. 11 and therefore has stronger diffractive properties. The lens phase in FIG. 10 and the grating phase in FIG. 13 can be combined, resulting in a phase distribution over the square-shaped out-coupling sub-region shown in FIG. 14. The phase distribution in FIG. 14 defines that of a lens structure that is offset from the center of the out-coupling sub-region. The offset value in FIG. 14 is larger compared to the offset shown in FIG. 12, with the lens center in FIG. 14 no longer positioned within the boundaries of the out-coupling sub-region.

In the case of the waveguide-based light emitting module of the present invention, a large number of out-coupling sub-regions can be employed, each subregion dedicated to efficient light out-coupling. The number of out-coupling sub-regions can be in excess of several thousand or more. The area occupied by the out-coupling sub-regions of the light emitting module serves as an output aperture of the module and is significantly larger than the out-coupling region of the near-eye display. Efficiency of the out-coupled light from the light emitting module is relatively high, as most of the out-coupled light from the different sub-regions is intended to be out-coupled through a limited number of interactions with the out-coupling sub-regions. The lateral placement of the out-coupling sub-regions of the light emitting module with respect to the in-coupling region and their diffractive properties are defined based on the specific requirements for the light out-coupled directions.

### ILLUSTRATIVE EMBODIMENTS

The light emitting module of the first embodiment shown in FIG. 1 is designed to operate at the wavelength of λ=0.94 μm. The module collimating lens has a clear aperture of 0.25 mm and is made as a monolithic block of fused silica with a nominal thickness of 0.70 mm placed in proximity to the in-coupling region of the waveguide. The back working distance of the collimating lens that defines the axial separation between the back surface of the lens and the emitter assembly is 0.55 mm. The diffractive optical power of the lens is defined by the lens phase polynomial Φ:

$$Φ = {A}_{1} {ρ}^{2} + {A}_{2} {ρ}^{4} + {A}_{3} {ρ}^{6} + {A}_{4} {ρ}^{8} \qquad ( 18 )$$

where ρ is the radial coordinate, and A₁, A₂, A₃ and A₄ are the radial phase coefficients of the lens diffractive surface, as defined in Table 1 below.

TABLE 1
Coefficients of the diffractive collimating lens

| Parameter | A₁ | A₂ | A₃ | A₄ |
|---|---|---|---|---|
| Value | −6002.4 | 175.6 | −992.4 | 1788.3 |

The waveguiding component is made of fused silica with refractive index 1.4512 and thickness of 1.0 mm. The in-coupling region is made as a grating structure working in the 1^{st} diffraction order, with the grating's nominal periodicity prescribed to be 862 nm. The grating lines are oriented normal to the light propagation direction within the waveguide.

As an example of a light emitting module in accordance with the present invention, we present the out-coupling region parameters for 45 transmissive diffractive out-coupling sub-regions of a waveguiding component. The transmissive diffraction gratings are working in the first diffraction order m=1 at the operating wavelength λ=940 nm. Each transmissive grating structure is designed to produce 9 TIRs within the waveguide before reaching the center of the out-coupling structure.

Parameters of the transmissive diffraction gratings within the individual out-coupling sub-regions and the associated output light beam directions are listed in Table 2.

TABLE 2
Parameters of the out-coupling gratings regions

| | Out-coupled | Out-coupled | | |
|---|---|---|---|---|
| | beams | beams | | Grating's |
| Out-coupling | X-axis | Y-axis | Grating's | azimuthal |
| sub-region's | directional | directional | periodicity | orientation |
| number j | component Sᵢₓ | component S_{iy} | dⱼ (μ) | φ_{g} (deg.) |
| 1 | 0 | 0 | 0.862 | 0.0 |
| 2 | 0.174 | 0 | 0.851 | 9.0 |
| 3 | 0.342 | 0 | 0.823 | 17.4 |
| 4 | 0.500 | 0 | 0.784 | 24.6 |
| 5 | 0.643 | 0 | 0.743 | 30.5 |
| 6 | −0.174 | 0 | 0.851 | −9.0 |
| 7 | −0.342 | 0 | 0.823 | −17.4 |
| 8 | −0.5 | 0 | 0.784 | −24.6 |
| 9 | −0.643 | 0 | 0.743 | −30.5 |
| 10 | 0 | 0.174 | 1.025 | 0 |
| 11 | 0.174 | 0.174 | 1.007 | 10.7 |
| 12 | 0.342 | 0.174 | 0.961 | 20.4 |
| 12 | 0.500 | 0.174 | 0.900 | 28.6 |
| 14 | 0.643 | 0.174 | 0.840 | 35.0 |
| 15 | −0.174 | 0.174 | 1.007 | −10.7 |
| 16 | −0.342 | 0.174 | 0.961 | −20.4 |
| 17 | −0.5 | 0.174 | 0.900 | −28.6 |
| 18 | −0.643 | 0.174 | 0.840 | −35.0 |
| 19 | 0 | −0.342 | 0.656 | 0 |
| 20 | 0.174 | −0.342 | 0.651 | 6.9 |
| 21 | 0.342 | −0.342 | 0.638 | 13.4 |
| 22 | 0.500 | −0.342 | 0.620 | 19.2 |
| 23 | 0.643 | −0.342 | 0.599 | 24.2 |
| 24 | −0.174 | −0.342 | 0.651 | −6.9 |
| 25 | −0.342 | −0.342 | 0.638 | −13.4 |
| 26 | −0.5 | −0.342 | 0.620 | −19.2 |
| 27 | −0.643 | −0.342 | 0.599 | −24.2 |
| 28 | 0 | 0.500 | 1.592 | 0 |
| 29 | 0.174 | 0.500 | 1.527 | 16.4 |
| 30 | 0.342 | 0.500 | 1.378 | 30.1 |
| 31 | 0.500 | 0.500 | 1.215 | 40.3 |
| 32 | 0.643 | 0.500 | 1.077 | 47.4 |
| 33 | −0.174 | 0.500 | 1.527 | −16.4 |
| 34 | −0.342 | 0.500 | 1.378 | −30.1 |
| 35 | −0.5 | 0.500 | 1.215 | −40.3 |
| 36 | −0.643 | 0.500 | 1.077 | −47.4 |
| 37 | 0 | −0.643 | 0.542 | 0 |
| 38 | 0.174 | −0.621 | 0.547 | 5.8 |
| 39 | 0.342 | −0.567 | 0.555 | 11.7 |
| 40 | 0.500 | −0.507 | 0.561 | 17.4 |
| 41 | 0.643 | −0.455 | 0.562 | 22.6 |
| 42 | −0.174 | −0.621 | 0.547 | −5.8 |
| 43 | −0.342 | −0.567 | 0.555 | −11.7 |
| 44 | −0.500 | −0.507 | 0.561 | −17.4 |
| 45 | −0.643 | −0.455 | 0.562 | −22.6 |

FIG. 15 presents an illustrative side view of the light emitting module along the waveguide propagation direction in accordance with the presented example. It shows the waveguiding component 1501 with planar interfaces and the out-coupled light beams 1502 emitted as a fan into multiple directions from the out-coupling region of the waveguiding component 1501. The specific directions of the individual beams correspond to the out-coupling sub-regions 1 through 9 with the gratings' parameters listed in Table 2. The out-coupled directions of the beams shown in FIG. 15 are incrementally spaced at equal angular intervals.

The present invention provides significant flexibility in defining directions of the out-coupled beams by adjusting the properties of the diffractive structures of the individual out-coupling sub-regions. FIG. 16 presents a second side view example of the light emitting module in accordance with the first embodiment of the present invention. It shows the waveguiding component 1601 with planar interfaces and light beams 1602 emitted into multiple directions from the out-coupling sub-regions of the waveguiding component 1601. The specific directions of the emitted beams 1602 correspond to the out-coupling sub-regions 1 through 9 with grating parameters listed in Table 3. The out-coupling directions of light beams in FIG. 16 are spaced at inequal angular intervals.

TABLE 3
Parameters of the out-coupling gratings' regions
for the second example

| | Out-coupled | Out-coupled | | |
|---|---|---|---|---|
| | beams | beams | | Grating's |
| Out-coupling | X-axis | Y-axis | Grating's | azimuthal |
| sub-region's | directional | directional | periodicity | orientation |
| number j | component Sᵢₓ | component S_{iy} | dⱼ (μ) | φ_{g} (deg.) |
| 1 | 0.1 | 0 | 0.862 | 5.3 |
| 2 | 0.6 | 0 | 0.755 | 28.8 |
| 3 | 0.75 | 0 | 0.710 | 34.5 |
| 4 | −0.2 | 0 | 0.848 | −10.4 |
| 5 | 0.17 | 0 | 0.852 | 8.9 |
| 6 | −0.5 | 0 | 0.784 | −24.6 |
| 7 | −0.55 | 0 | 0.770 | −26.8 |
| 8 | −0.6 | 0 | 0.755 | −28.8 |
| 9 | −0.65 | 0 | 0.740 | −30.8 |

FIG. 17 presents a side view of the second embodiment of the light emitting module in accordance with the present invention. The light emitting module 1700 contains an assembly of emitters 1701, a planar lens 1702, and a waveguiding component 1703 with planar interfaces defined by surfaces 1707 and 1708. The waveguiding component contains an in-coupling region 1709 fabricated on surface 1708 and an out-coupling region 1710 fabricated on surface 1707. The in-coupling region 1709 and the out-coupling region 1710 can incorporate different diffractive structures. FIG. 17 also shows the waveguided light 1705 within the waveguiding component 1703, and the output light beams 1704 emitted in multiple directions from the out-coupling region 1710. The lens 1702 and the waveguiding component 1703 have a spacing 1711 with a value of 300 microns. The rest of the optical parameters and prescription details of the second embodiment in FIG. 17 are the same as in the illustrative example of the first embodiment in FIG. 1.

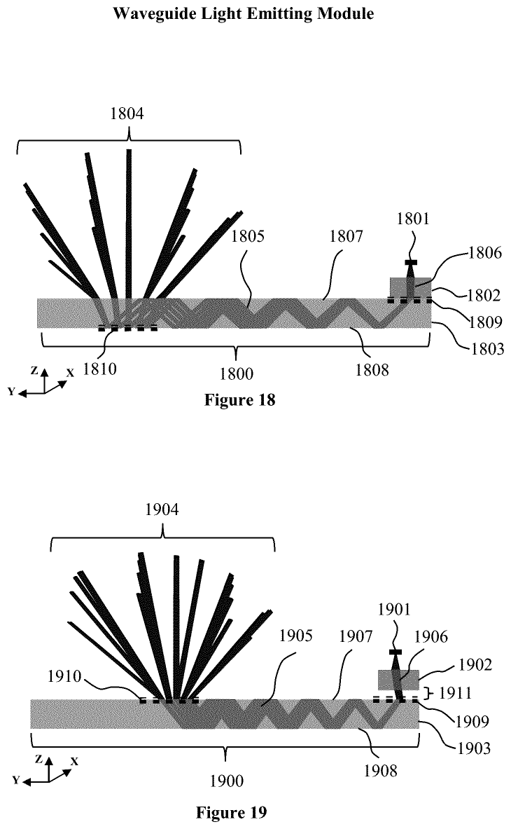

FIG. 18 presents a side view of the third embodiment of the light emitting module in accordance with the present invention. The light emitting module 1800 contains an assembly of emitters 1801, a planar lens 1802, and a waveguiding component 1803 with planar interfaces defined by surfaces 1807 and 1808. The lens 1802 and the waveguiding component 1803 are placed in proximity to each other. FIG. 18 also shows the waveguided light 1805 within the waveguiding component 1803, and the output light beams 1804 emitted in multiple directions from the out-coupling region 1810. The waveguiding component contains an in-coupling region 1809 fabricated on surface 1807 and an out-coupling region 1810 fabricated on surface 1808. The rest of the optical parameters and prescription details of the third embodiment in FIG. 18 are the same as in the illustrative example of the first embodiment in FIG. 1.

FIG. 19 presents a side view of the fourth embodiment of the light emitting module in accordance with the present invention. The light emitting module 1900 contains an assembly of emitters 1901, a planar lens 1902, and a waveguiding component 1903 with planar interfaces defined by surfaces 1907 and 1908. Emitter assembly 1901 is laterally offset pictorially in the y-dimension from the center of the lens 1902, resulting in angular tilt of the collimated light 1906. The offset can be a combination of both the x- and y-dimensions. The lens 1902 and the waveguiding component 1903 are spaced from each other. The waveguiding component 1903 contains an in-coupling region 1909 fabricated on surface 1907 and an out-coupling region 1910 fabricated on surface 1907. The in-coupling region 1909 and the out-coupling region 1910 can incorporate different diffractive structures. The collimated light 1906 is incident at an angle onto the in-coupling region 1909. FIG. 19 also shows the waveguided light 1905 within the waveguiding component 1903, and the output light beams 1904 emitted in multiple directions from the out-coupling region 1910. Emitter assembly 1901 and the lens 1902 are laterally offset from each other by 100 microns. The lens 1902 and the waveguiding component 1903 have a spacing 1911 with a value of 300 microns. The rest of the optical parameters and prescription details of the fourth embodiment in FIG. 19 are the same as those in the illustrative example of the first embodiment in FIG. 1.

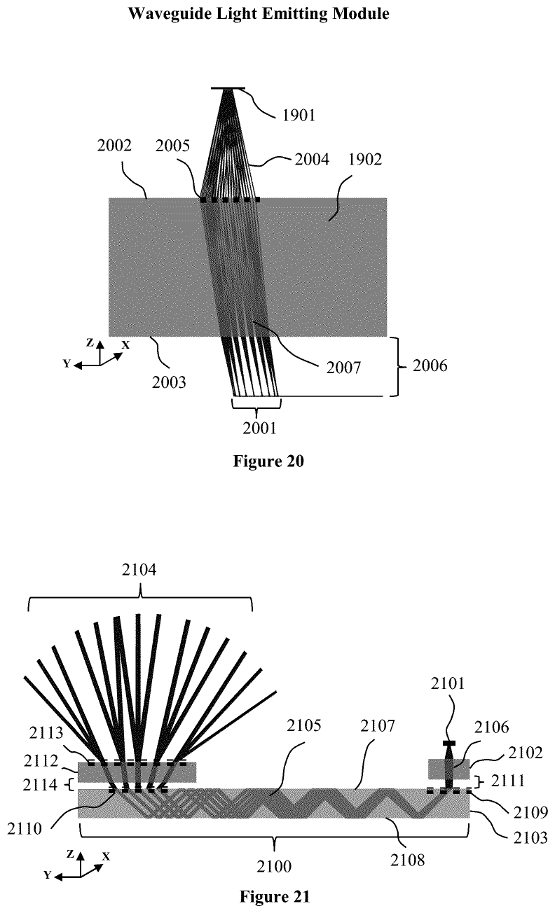

FIG. 20 shows light propagation details of the fourth embodiment from an assembly of emitters 1901 through the lens 1902 onto the lens exit aperture 2001. The lens 1902 consists of a block of an optical material transparent within the spectral region of the waveguide-based light emitter, such as optical glass, silicon, or fused silica. The lens 1902 has two plane parallel optical surfaces 2002 and 2003. Alternative lens designs may contain diffractive regions fabricated on both lens surfaces 2002 and 2003, or solely on one of the lens surfaces. Lens 1902 shown in FIG. 20 has a single diffractive structure 2005 placed on surface 2002 facing the emitter assembly 1901. In addition to light collimation, diffractive region 2005 is designed to steer the light at an angle with respect to the lens surfaces 2002 and 2003. Diffractive structure 2005 has a phase profile with center offset, similar to that shown in FIG. 12 or 14. Emitted diverging light 2004 from the assembly of emitters 1901 is collimated by the diffractive structure 2005 and is directed as a bundle 2007 at an angle to the surface 2002 onto the lens exit aperture 2001 located after the lens surface 2003. The distance 2006 between the lens surface 2003 and the exit aperture 2001 is 300 microns. Diffractive region 2004 can be made as a diffractive phase structure, such as meta-surface, geometrical phase surface, volume hologram, multi-step binary surface, etc.

To reduce the beam sparsity of the output illumination, it is desirable to increase the number of the output emitted light beams. That is achieved by the out-coupling sub-regions that may contain beam-splitting structures that produce several secondary output beams from each of the out-coupling sub-regions. Alternatively, the increase in the number of the output emitted light beams may be achieved by adding a beam splitting component placed over the out-coupling region. The beam-splitting component will produce several additional output beams from each of the out-coupled beams emerging from the out-coupling sub-regions.

FIG. 21 presents a side view of the fifth embodiment of the light emitting module with the beam-splitting structures in accordance with the present invention. The light emitting module 2100 contains an assembly of emitters 2101, a planar lens 2102, and a waveguiding component 2103 with planar interfaces defined by surfaces 2107 and 2108. The lens 2102 and the waveguiding component 2103 are spaced apart from each other by a spacing 2111. The waveguiding component 2103 contains an in-coupling region 2109 fabricated on surface 2107 and an out-coupling region 2110 fabricated on surface 2107. The in-coupling region 2109 and the out-coupling region 2110 can incorporate different transmissive diffractive structures. Emitter assembly 2101 is centered with respect to the lens 2102, resulting in normal incidence of the collimated light 2106 onto the in-coupling region 2109 of the waveguiding component 2103. FIG. 21 also shows the waveguided light 2105 within the waveguiding component 2103. An additional component 2112 incorporating transmissive diffractive beam-splitting structure 2113 is placed above the out-coupling region 2110. The beam-splitting structure 2112 and the out-coupling region 2110 of the waveguiding component 2103 are spaced from each other by a spacing 2114. The light beams out-coupled from the region 2110 are directed onto the beam-splitting structure 2113 of the beam-splitting component 2112. Each of the out-coupled beams from region 2110 is split into several beams propagating at different directions, as shown in FIG. 21. The output beams 2104 after the beamsplitter 2112 may have equal or different intensities. The lens 2102 and the waveguiding component 2103 are spaced from each other by 300 microns. The beam-splitting component 2112 and the waveguiding component 2103 are spaced from each other by 200 microns. The beam-splitting component 2112 is made of fused silica with refractive index 1.4512 and thickness of 0.7 mm. The beam-splitting region is made as a periodic transmissive diffractive structure working in the −1^{st}, 0^{th}, and 1^{st} diffraction orders, with a period of 6.5 microns. The rest of the optical parameters and prescription details of the fifth embodiment in FIG. 21 are the same as those in the illustrative example of the first embodiment in FIG. 1.

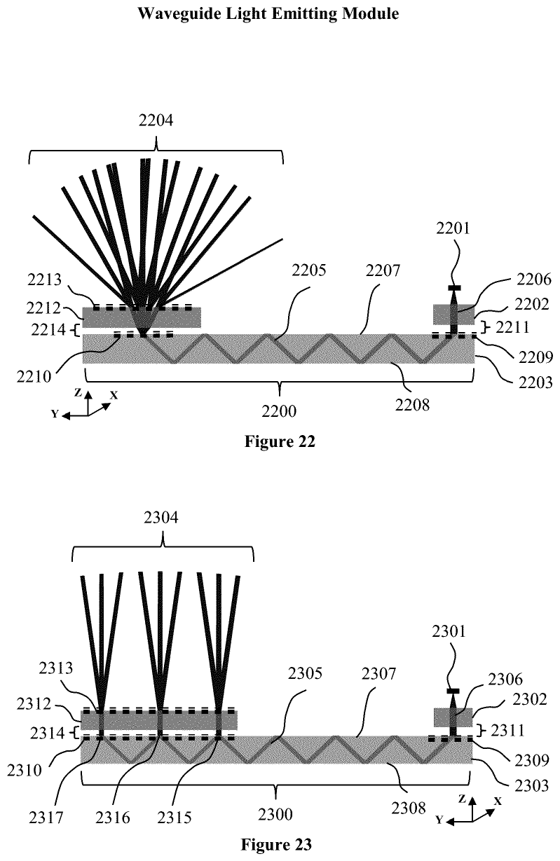

FIG. 22 presents a side view of the sixth embodiment of the light emitting module with the beam-splitting structures in accordance with the present invention. The light emitting module 2200 contains a single emitter 2201, a planar lens 2202, a waveguiding component 2203 with planar interfaces defined by surfaces 2207 and 2208, and a beam-splitting component 2212 containing beam-splitting diffraction grating 2213. The lens 2202 is spaced from the waveguiding component 2203 by a spacing 2211. The beam-splitting component 2212 is spaced from the waveguiding component 2203 by a spacing 2114. The waveguiding component 2203 contains an in-coupling region 2209 fabricated on surface 2207 and an out-coupling region 2210 fabricated on surface 2207. Emitter 2201 is centered with respect to the lens 2202, resulting in normal incidence of the collimated light 2206 onto the in-coupling region 2209 of the waveguiding component 2203. FIG. 22 also shows the waveguided light 2205 within the waveguiding component 2203. The out-coupling region 2210 is made as a beam-splitting component. The collimated light 2205 is out-coupled by transmissive diffractive out-coupler 2210 in the form of multiple secondary beams directed onto the beam-splitter 2212 at different angles. Each of the secondary beams out-coupled from the region 2210 is split by the beam-splitting surface 2213 into several beams that propagate in different directions, and result in the array of output beams 2204, as shown in FIG. 22. The output beams 2204 at the output of the beamsplitter 2213 may have equal or different intensities. The lens 2202 and the waveguiding component 2203 are spaced from each other by 300 microns. The beam-splitting component 2212 and the waveguiding component 2203 are spaced from each other by 200 microns. The beam-splitting component 2212 is made of fused silica with refractive index 1.4512 and thickness of 0.7 mm. The beam-splitting region 2210 of the waveguiding component 2203 is made as a periodic transmissive diffractive structure with the period of 0.86 microns that splits the out-coupled beam into 5 secondary beams diffracted into orders −2^{nd}, −1^{st}, 0^{th}, 1^{st}, and 2^{nd}. The beam-splitting region of the beam-splitting component 2212 is made as a periodic transmissive diffractive structure with the period of 4.0 microns that diffracts each of the incoming beams into the −1^{st}, 0^{th}, and 1^{st} diffraction orders. The rest of the optical parameters and prescription details of the sixth embodiment in FIG. 22 are the same as those in the illustrative example of the first embodiment in FIG. 1.

FIG. 23 presents a side view of the seventh embodiment of the light emitting module with the beam-splitting structures in accordance with the present invention. The light emitting module 2300 contains a single emitter 2301, a planar lens 2302, a waveguiding component 2303 with planar interfaces defined by surfaces 2307 and 2308, and a beam-splitting component 2312 containing beam-splitting diffraction grating 2313. The lens 2302 is spaced from the waveguiding component 2203 by a spacing 2311. The beam-splitting component 2312 is spaced from the waveguiding component 2203 by a spacing 2314. The waveguiding component 2303 contains an in-coupling region 2309 fabricated on surface 2307 and an out-coupling region 2310 fabricated on surface 2307. Emitter 2301 is centered with respect to the lens 2302, resulting in normal incidence of the collimated light 2306 onto the in-coupling region 2309 of the waveguiding component 2303. FIG. 23 also shows the waveguided light 2305 within the waveguiding component 2303. When the waveguided collimated light 2305 reaches the out-coupling region 2310 in the area 2314, only a fraction of light is out-coupled and directed towards the beam-splitting region 2313 of the beam splitter 2312. The rest of the collimated light continues to propagate within the waveguide 2303 experiencing total internal reflection. The waveguided light has multiple intersections with the out-coupling region 2310. FIG. 23 shows three intersections with the out-coupling region 2310 denoted as 2315, 2316, and 2317. Diffractive properties of the out-coupling region 2310 in the areas of the intersections 2315 through 2317 can be the same across the entire region or can change across the out-coupling region 2310. The out-coupling region 2310 can also be composed of several out-coupling sub-regions with different diffractive properties in the areas of the intersections 2315 through 2317.

The collimated light 2305 out-coupled from the regions 2315, 2316, and 2317 of the transmissive diffractive out-coupling region 2310 is directed onto the beam-splitting transmissive diffractive region 2313 of the beam-splitter 2312. Each of the collimated beams out-coupled from the region 2310 is split by the beam-splitting surface 2312 into several secondary beams propagating in different directions, and resulting in an array of output beams 2304, as shown in FIG. 23. The output beams 2304 after the beamsplitter 2313 may have equal or different intensities.

The lens 2302 and the waveguiding component 2303 are spaced from each other by 300 microns. The beam-splitting component 2312 and the waveguiding component 2303 are spaced from each other by 200 microns. The beam-splitting component 2312 is made of fused silica with refractive index 1.4512 and thickness of 0.7 mm. The out-coupling region 2310 of the waveguiding component 2303 is made as a homogeneous periodic transmissive diffractive grating with the period of 862 nanometers. The beam-splitting region of the beam-splitting component 2312 is made as a periodic transmissive diffractive structure working in the −1^{st}, 0^{th}, and 1^{st} diffraction orders, with the period of 6.5 microns. The rest of the optical parameters and prescription details of the seventh embodiment in FIG. 23 are the same as those in the illustrative example of the first embodiment in FIG. 1.

To improve homogeneity of the output light and reduce the appearance of dark regions, diffractive beam-splitting elements, such as 2312 in FIG. 23, can be replaced with light diffusers that spread the incident beams over an angular range defined by the diffuser designs. Alternatively, the light emitting module of the present invention may contain an actuation mechanism for position adjustment of emitters with respect to the collimating lens. The actuation mechanism may perform one-dimensional and two-dimensional lateral positional adjustments of the emitters or the diffractive lens. It may also perform axial positional adjustments between emitters and the lens to adjust divergence of the waveguided light. A number of actuation mechanisms can be employed, including micro-electro-mechanical systems (MEMS) actuators and voice-coil actuators (VCAs). Based on the emitter assembly or the lens actuation, the out-coupled light beams will adjust their angular directions and divergence, sequentially covering broader angular space.

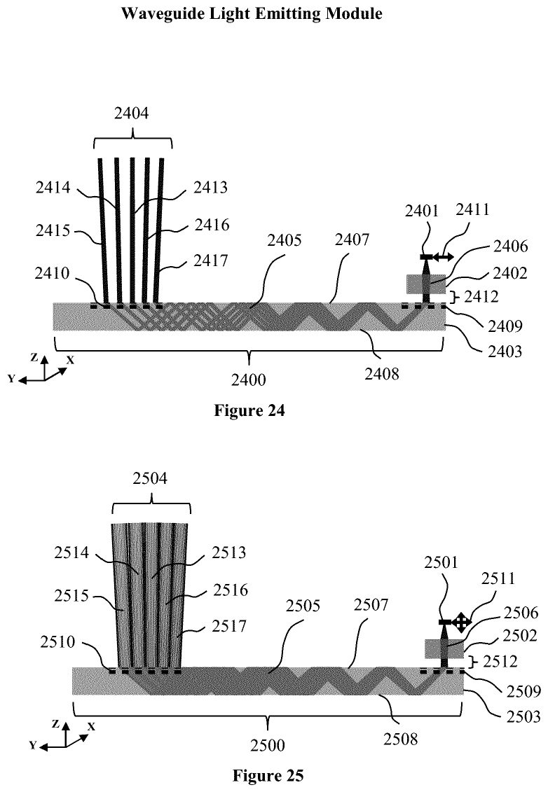

FIG. 24 presents a side view of the eighth embodiment of the light emitting module 2400 with an actuation mechanism in accordance with the present invention. The light emitting module 2400 contains a single emitter 2401, a planar lens 2402, a waveguiding component 2403 with planar interfaces defined by surfaces 2407 and 2408. The axial spacing between emitter 2401 and the lens 2402 is 0.55 microns, corresponding to the collimated light at the output of the lens 2402. The light emitting module 2400 also contains an actuation mechanism 2411 for lateral adjustment of the emitter 2401 with respect to the lens 2402. The lens 2402 is spaced from the waveguiding component 2403 by a spacing 2412. The waveguiding component 2403 contains an in-coupling region 2409 fabricated on surface 2407 and an out-coupling region 2410 fabricated on surface 2407. FIG. 24 also shows the waveguided light 2405 within the waveguiding component 2403. When the actuation mechanism 2411 adjusts the lateral position of the emitter 2401 relative to the lens 2402, that results in changes to the angle of incidence of the collimated light 2406 onto the in-coupling region 2409. Changes in the angle of incidence will lead to the corresponding changes in the in-coupled angle into the waveguide 2403. When the waveguided collimated light 2405 reaches the out-coupling region 2410, it is out-coupled as one of the output beams 2404. FIG. 24 shows five out-coupled beams 2413, 2414, 2415, 2416, and 2417 corresponding to five relative lateral displacements of the emitter 2401 with respect to the lens 2402. In the specific example shown in FIG. 24, the lateral displacements between emitter 2401 and the lens 2402 were adjusted by the actuator 2411 in increments of 12 micrometers. Similar effects can be observed when actuation of the lens 2402 is performed, rather than actuation of the light emitting module 2401. Distance between the light emitter 2401 and the lens 2402 was 0.55 microns, corresponding to a collimated light incident onto the in-coupling region 2410. The lens 2402 and the waveguiding component 2403 are spaced from each other by 300 microns. In the example shown in FIG. 24 the out-coupling region 2410 of the waveguiding component 2403 is made as a homogeneous periodic transmissive diffractive grating with the period of 862 nanometers across the entire out-coupling region. The out-coupling region 2410 can also be made to change its diffraction properties across the out-coupling area. For example, it can be composed of several out-coupling sub-regions with different transmissive diffractive properties in the areas of the intersections of the out-coupled beams 2413 through 2417 with the out-coupling region 2410. The rest of the optical parameters and prescription details of the eighth embodiment in FIG. 24 are the same as those in the illustrative example of the first embodiment in FIG. 1.

FIG. 25 presents a side view of the ninth embodiment of the light emitting module 2500 containing actuation mechanism in accordance with the present invention. The light emitting module 2500 contains a single emitter 2501, a planar lens 2502, and a waveguiding component 2503 with planar interfaces defined by surfaces 2507 and 2508. The light emitting module 2500 also contains an actuation mechanism 2511 capable of both the lateral and axial adjustments of the emitter 2501 with respect to the lens 2502. The lens 2502 is spaced from the waveguiding component 2503 by a spacing 2512. The waveguiding component 2503 contains an in-coupling region 2509 fabricated on surface 2507 and an out-coupling region 2510 fabricated on surface 2507. FIG. 25 also shows the waveguided light 2505 within the waveguiding component 2503. Adjustments of the relative lateral position of the emitter 2501 with respect to the lens 2502 by the actuation mechanism 2511 will result in changes to the incident angle of light 2506 onto the in-coupling region 2509. Changes in the angle of incidence will lead to the corresponding changes in the in-coupled angle into the waveguide 2503. Adjustments in the axial position between the emitter 2501 and the lens 2502 will result in divergence angle changes of the emitter light 2506 incident onto the in-coupling region 2509. FIG. 25 illustrates the case when the axial distance between emitter 2501 and the lens 2502 is 0.53 microns, corresponding to the reduction by 20 microns from the collimated value of 0.55 microns. When the diverging in-coupled light 2505 reaches the out-coupling region 2510, it is out-coupled as one of the output beams 2504. FIG. 25 shows five out-coupled beams 2513, 2514, 2515, 2516, and 2517 corresponding to five relative lateral displacements of the emitter 2501 with respect to the lens 2502. In the specific example shown in FIG. 25, the lateral displacements between emitter 2501 and the lens 2502 were adjusted by the actuator 2511 in increments of 12 micrometers. Similar changes in the out-coupling beam 2504 can be observed when actuation of the lens 2502 is performed, rather than actuation of the light emitting module 2501. The lens 2502 and the waveguiding component 2503 are spaced from each other by 300 microns. In the example shown in FIG. 25 the out-coupling region 2510 of the waveguiding component 2503 is made as a homogeneous periodic diffraction grating with the period of 862 nanometers across the entire out-coupling region. The out-coupling region 2510 can also be made to change its diffraction properties across the out-coupling area. For example, it can be made composed of several out-coupling sub-regions with different diffractive properties in the areas of the intersections of the out-coupled beams 2513 through 2517 with the out-coupling region 2510. The out-coupling region 2510 can be also made with diffractive properties continuously changing across the region. For example, the grating ridge spacing, width and height can be gradually adjusted. When the region 2510 is composed of sub-wavelength meta-atoms, the meta-atoms' properties, such as their spacing, shape and size can be adjusted across the out-coupling area 2510. The rest of the optical parameters and prescription details of the ninth embodiment in FIG. 25 are the same as in the illustrative example of the first embodiment in FIG. 1.

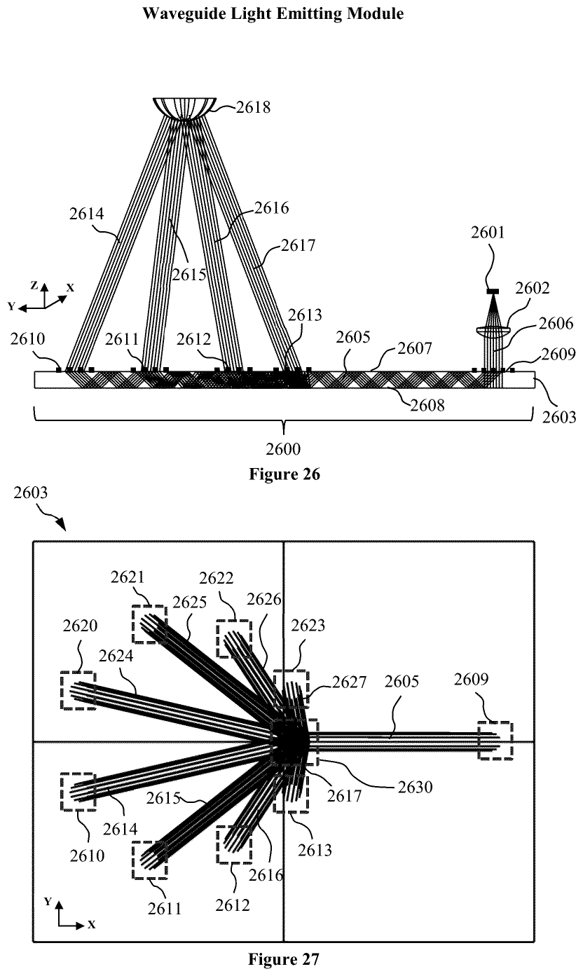

In many applications, such as eye tracking, biometric identification, and endoscopy, it is desirable to provide illumination to spatially localized regions, or receive light from and to produce imagery of spatially localized regions. FIG. 26 presents a side view of the light emitting waveguiding module 2600 in the YZ plane in accordance with the tenth embodiment of the present invention. The light emitting module 2600 contains a light source 2601, a collimating lens 2602, and a waveguiding component 2603 with planar interfaces defined by surfaces 2607 and 2608. The lens 2602 collects the light emitted from the source 2601 and is spaced from the waveguiding component 2603. The waveguiding component 2603 contains an in-coupling region 2609 and several out-coupling regions 2610, 2611, 2612, and 2613 fabricated onto the surface 2607. The in-coupling region 2609 and the out-coupling regions 2610 through 2613 can incorporate different types of diffractive structures, such as meta-surfaces, geometrical phase surfaces, volume holograms, multi-step binary surfaces, etc. The diffractive structures may have different diffractive properties, and can be made as transmissive or as reflective diffractive structures. Diffractive structures can be fabricated using a variety of techniques, such as projection lithography, nano-imprint, holographic recording, etc. While FIG. 26 schematically shows 4 out-coupling regions, a larger or a smaller number of the out-coupling regions can be used, based on the specific application requirements. Several light sources with associated collecting lenses and in-coupling regions can be included as part of the waveguide-based module to illuminate multiple regions or enhance illumination of a single region. The light sources may have different spectral compositions. The in-coupling regions can de designed to produce highest in-coupling efficiencies for different operating wavelengths.

FIG. 26 shows collimated light 2606 from the source 2601 at the output of the lens 2602. The collimated light 2606 is in-coupled into the waveguide 2603 by the in-coupling structure 2609. The in-coupled light 2605 propagates within the waveguide 2603 towards the out-coupling regions 2610 through 2613. A fraction of the in-coupled light is out-coupled from the waveguiding component 2603 by the out-coupling regions 2610 through 2613, and are directed as individual beams 2614, 2615, 2616, and 2617 towards the surface of an object 2618. Diffractive structures within the out-coupling regions have different properties, resulting in different angles of the out-coupled beams 2614 through 2617.

FIG. 27 presents a top view of the waveguiding component 2603 of the tenth embodiment. It contains the in-coupling region 2609, beam-splitting region 2630, and out-coupling regions 2610, 2611, 2612, 2613, 2620, 2621, 2622 and 2623. FIG. 27 also shows propagation of the collimated in-coupled beam 2605 towards the beam-splitting region 2630, where the collimated beam 2605 is split into secondary beams 2614, 2615, 2616, 2617, 2624, 2625, 2626, and 2627. The secondary beams 2614, 2615, 2616, 2617, 2624, 2625, 2626, and 2627 propagate within the waveguiding component 2603 towards the out-coupling regions 2610, 2611, 2612, 2613, 2620, 2621, 2622 and 2623, where the secondary beams are out-coupled from the waveguiding component 2603 and are directed towards the objects or regions of interest 2618.

The specific directions of the out-coupled beams 2614 through 2617 correspond to the out-coupling sub-regions 2610 through 2613 with grating parameters listed in Table 4. Directions of the out-coupled beams 2613 through 2617 in FIG. 26 are shown converging towards the object or region of interest 2618.

TABLE 4
Parameters of the out-coupling gratings' regions for the tenth's embodiment

| | | Grating's azimuthal |
|---|---|---|
| Out-coupling | Grating's | orientation |
| sub-region | periodicity dⱼ (μ) | φ_{g} (deg.) |
| 2610 | 0.643 | 47.0 |
| 2611 | 0.655 | 58.2 |
| 2612 | 0.712 | 66.6 |
| 2613 | 0.749 | 76.1 |
| 2620 | 0.643 | −47.0 |
| 2621 | 0.655 | −58.2 |
| 2622 | 0.712 | −66.6 |
| 2623 | 0.749 | −76.1 |

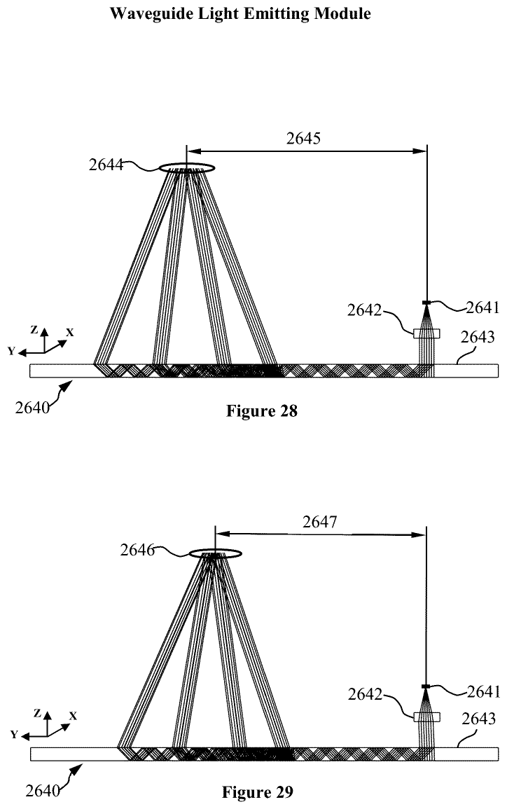

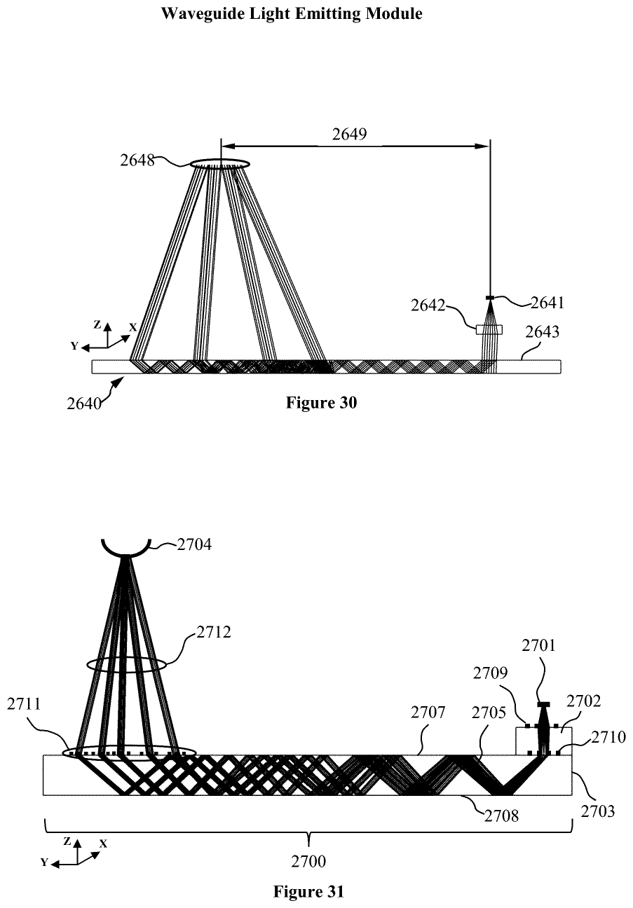

Adjusting the source lateral coordinate in the XY-plane can be used to control the lateral position of the converging beams at the object or region of interest, as shown in FIGS. 28, 29, and 30. FIG. 28 presents a light-emitting module containing the light source 2641, flat collimating lens 2642, and the waveguiding component 2643. The source 2641 axis is concentric with the collimating lens 2642 axis, and the distance from the lens 2642 axis to centroid of the beams 2644 along the Y-axis of the coordinate system is defined as 2645. The centroid of the beams may also be referred to as the region of interest. FIG. 29 presents light-emitting module 2640 when the light source 2641 is shifted in the positive Y-axis direction. That results in the centroid 2646 of the out-coupled beams shifting in the negative Y-axis direction, so that the distance 2647 between the beams centroid 2646 and the source 2641 becomes shorter than the original distance 2645 in FIG. 28. FIG. 30 presents light-emitting module 2640 when the light source 2641 is shifted in the negative Y-axis direction. That results in the centroid 2648 of the out-coupled beams shifting in the positive Y-axis direction, so that the distance 2649 between the beams centroid 2648 and the source 2641 becomes longer than the original distance 2645 in FIG. 28.

Alternatively, the light emitting module may contain an assembly of light sources rather than a single source. FIG. 31 presents a side view of the eleventh embodiment of the present invention. The light emitting module 2700 contains an assembly of light emitting sources 2701, a flat lens 2702, and a waveguiding component 2703. The collimating lens 2702 contains a diffractive structure 2709 that defines the phase profile required for light collimation. The lens 2702 collimates light from the individual sources contained within the assembly 2701. The collimated light is incident onto the waveguiding component 2703 and is in-coupled into the waveguiding component by the in-coupling region 2710. The in-coupled light propagates within the waveguide 2703 until it reaches an array of out-coupling regions 2711, where light is out-coupled from the waveguiding component 2703. Multiple out-coupled light beams 2712 emerging from the individual out-coupling regions 2711 of the waveguide 2703 are directed towards the object 2704.

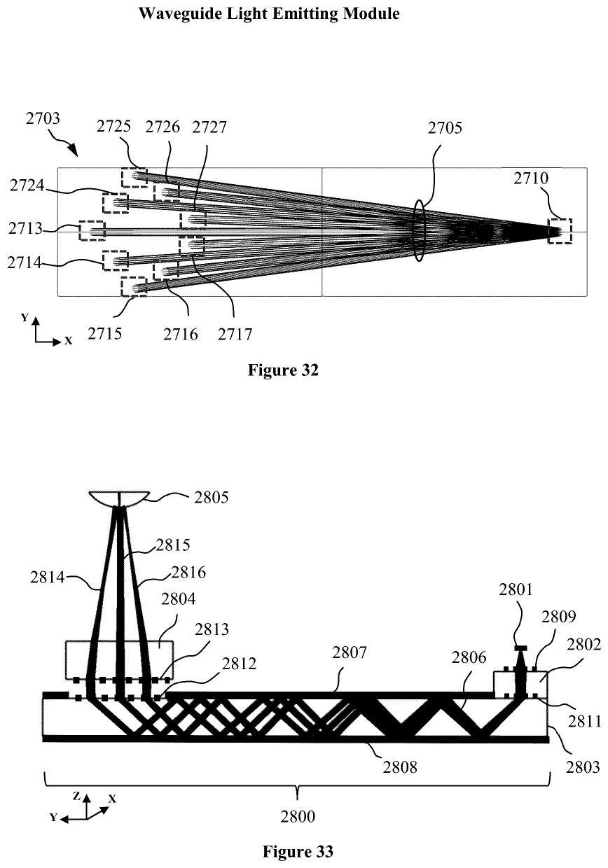

FIG. 32 present the top view of the waveguiding component 2703. It contains the in-coupling region 2710, as well as the out-coupling regions 2713, 2714, 2715, 2716, 2717, 2724, 2725, 2726, and 2727. Design of the out-coupling regions of the waveguiding component 2703 has X-axis symmetry. The out-coupling regions 2714, 2715, 2716, 2717 and the respective out-coupling regions 2724, 2725, 2726, 2727 are located symmetrically with respect to the X-axis of the coordinate system. In-coupled beams 2705 originating from the individual light sources of the assembly 2701 propagate within the waveguiding component 2703 until they reach the out-coupling regions 2713, 2714, 2715, 2716, 2717, 2724, 2725, 2726, and 2727 that are designed to out-couple the light and to directed it towards the object 2704. FIG. 31 shows multiple out-coupled beams 2712 exiting waveguiding component 2703 and converging onto the object 2704.

FIG. 33 presents a side view of the waveguiding module in accordance with the twelfth embodiment of the present invention. The waveguiding module 2800 contains an assembly of light emitting sources 2801, a flat collimating lens 2802, a waveguiding component 2803, and an additional light shaping component 2804. The collimating lens 2802 contains a diffractive structure 2809 that defines the lens phase profile required for light collimation. Lens 2802 collimates light from the individual sources contained within the assembly 2801 and directs it onto the in-coupling region 2811 of the waveguiding component 2803. The in-coupled collimated light 2806 propagates within the waveguide 2803 until it reaches an array 2812 of out-coupling regions. Multiple out-coupled light beams emerging from the array 2812 of the out-coupling regions are directed towards the light shaping component 2804. The light shaping component 2804 contains a transmissive diffractive phase structure on one of the surfaces. FIG. 33 shows transmissive diffractive structure 2813 on the surface of the component 2804 facing the waveguide 2803. Diffractive structure 2813 can be made as a phase structure defining a lens with positive optical power converging out-coupled beams 2814, 2815 and 2816 onto the object 2805. Alternatively, transmissive diffractive structure 2813 can be made as a phase structure composed of multiple diffractive gratings subregions, where the grating subregions diffracts out-coupled beams 2814, 2815 and 2816 towards the object 2805.

To protect the waveguiding component 2803 from contamination and to reduce propagation losses within the waveguide, the top 2807 and bottom 2808 surfaces of the waveguide 2803 may contain cladding layers of optically transparent material that has index of refraction n_{c} that is lower than refractive index of the waveguide substrate nₛ. The layers 2807 and 2808 protect the evanescent fields of the propagating waveguided modes from being affected externally. Evanescent decay length L_{dec} of a waveguided mode with the wavelength of λ is calculated as:

$${L}_{dec} = \frac{λ}{2 π} \frac{1}{\sqrt{{( {n}_{s} )}^{2} - {( {n}_{c} )}^{2}}} \qquad ( 19 )$$

For the operating wavelength of λ=0.94 microns and the substrate made of fused silica, the decay length L_{dec} depends on the refractive index of the cladding layer n_{c}, and can range from about 0.5 microns to several microns. The thickness of the layers 2807 and 2808 is selected to be several times the evanescent decay length L_{dec}, and can be made anywhere between 2-3 microns to several tens of microns.

The cladding structure may also consist of a multi-layer stack composed of materials with different refractive indices. It can also be made as a gradient index layer, where the index of refraction is gradually changing within the layer. In some cases, the cladding layer can be locally removed, at least partially, to incorporate the in-coupling or the out-coupling regions, as is shown in FIG. 33 for the upper cladding layer 2807, where a portion of it is cleared for the out-coupling structure 2812. Alternatively, the in-coupling and the out-coupling regions can be encapsulated within the cladding layer or another optically transparent material. As another alternative, the cladding layer can be replaced with a highly reflective optical coating, such as a multi-layer dielectric film stack or a layer of metal, such as gold or aluminum. Transparent or partially transparent regions can be made within the highly reflective layer to incorporate the in-coupling and the out-coupling regions of the waveguide.

The next embodiment of the present invention is designed to perform light sensing and light emission through an image-forming display structure. Image-forming displays are built from individual light-emitting pixels, such as organic light-emitting diodes (O-LEDs) or micro-LEDs. FIG. 34 presents a side view of the waveguiding module 2900 placed behind the display. The waveguiding module 2900 contains an assembly of light emitting sources 2901, a flat collimating lens 2902, and a waveguide 2903. The module 2900 is placed behind a display 2940. The collimating lens 2902 contains a diffractive structure 2905 that defines the lens phase profile required for light collimation.

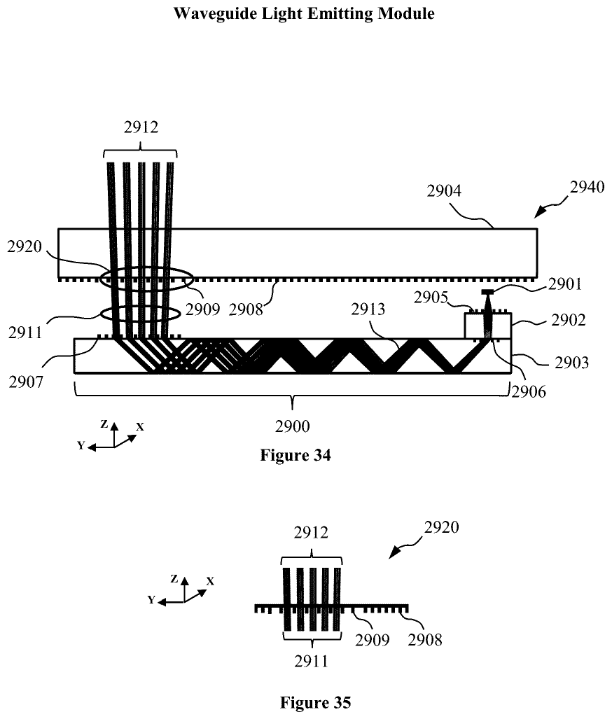

Collimated light from the individual emitters of the assembly 2901 at the output of the lens 2902 is directed onto the transmissive diffractive in-coupling region 2906 of the waveguide 2903. The in-coupled light 2908 will propagate within the waveguide 2903 until it reaches the out-coupling region 2907. Diffracted out-coupled beams 2911 are directed towards the display 2940. Display 2940 is schematically shown in FIG. 34 as a transparent substrate 2904 with a layer of image-forming light emitting pixels 2913 facing the waveguiding module 2900. Image-forming layer of light emitting pixels 2913 may contain regions with reduced density of pixels 2909. FIG. 35 shows an enlarged region 2920 of the display 2940. FIG. 35 shows part of a display window surface facing the waveguiding module 2900 that has an image-forming layer with reduced pixels density 2909 placed next to an image-forming layer with higher pixels density 2913. It also shows out-coupled diffracted beams 2911 transmitted through the display region 2909 and forming an array of output beams 2912. Incident beams 2911 will experience diffraction on the arrangement of the image-forming pixels of the region 2909, that can be observed after display substrate 2904. The size, lateral spacing and patterns of the image-forming pixels can be designed to enhance formation of structured light at the output of the display substrate 2904. Alternatively, the waveguiding module 2900 can be employed to sense light transmitted through the display region 2909. In that case, design of the display region 2909, including the size, lateral spacing and patterns of the image-forming pixels, can be used to clean-up the sensor signals or images by filtering out spatial frequency components that are associated with the chosen designs of the display region 2909.

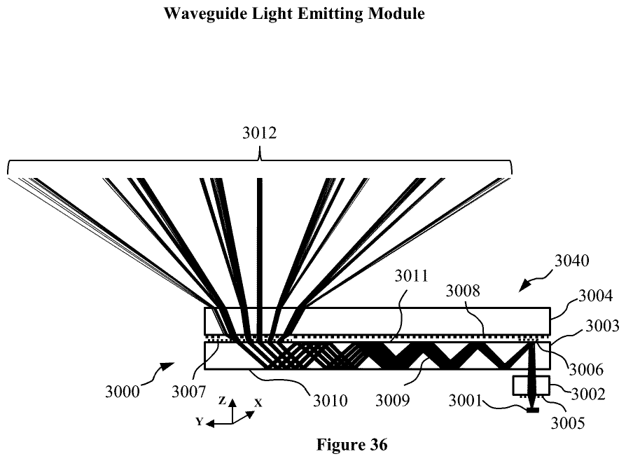

FIG. 36 presents a side view of an alternative layout of the waveguiding module 3000 placed behind the display 3040. The waveguiding module 3000 contains an assembly of light emitting sources 3001, a flat collimating lens 3002, and a waveguide 3003. The display module contains a transparent substrate 3004 and an image-forming pixelated structure 3008. The collimating lens 3002 is placed on the waveguide 3003 side 3010 that is opposite to the display 3040 and contains a transmissive diffractive structure 3005 that defines the lens phase profile required for light collimation. The waveguide 3003 contains a reflective diffractive in-coupling region 3006 and a transmissive diffractive out-coupling region 3007, both on the waveguide 3003 side 3011 nearest to the display 3040. The in-coupled reflected light 3009 propagates within the waveguide 3003 until it reaches the out-coupling region 3007, and is diffracted towards the display 3040, where it diffracts on the display pixelated structure 3008 and exits through the display substrate 3004 as a set of rays 3011. Placement of the lens 3002 on the waveguide side 3010 opposite the display 3040 allows the waveguide 3003 to be placed in proximity to the display pixelated structure.

The waveguide-based light emitting modules of the present invention may include multiple assemblies of light emitters, multiple respective light collecting lenses and multiple respective in-coupling regions. The in-coupling regions of the waveguide-based light emitting modules can be divided into multiple sub-regions to control the directionality of the in-coupled light. The waveguide-based light sensing modules of the present invention may include multiple photosensitive pixelated arrays or individual sensing components, multiple respective light collecting lenses and multiple respective out-coupling regions. The out-coupling regions of the waveguide-based light sensing modules can be divided into multiple sub-regions to control the direction of the out-coupled light.

The implementation details of the waveguide-based light-emitting and sensing modules in accordance with the present invention provide specific design examples of the system. It is understood that numerous other examples of light emitting and sensing modules can be constructed by those skilled in the art based on the provided description and associated details, and using different output light beam directions, operating wavelengths, waveguide geometries, and materials.

1. A waveguide-based light emitting module for producing multiple output light beams, the module comprising:
an assembly of light emitting sources;
an optical waveguiding component including a diffractive in-coupling region and a diffractive out-coupling region;
a lens positioned between the light emitting sources and the optical waveguiding component to collect light emitted by the light emitting sources and direct the light onto the diffractive waveguide in-coupling region;
wherein said diffractive out-coupling region of the waveguiding component includes a plurality of out-coupling sub-regions configured to direct at least a fraction of the out-coupled light towards a region spatially separated from the light emitting module, and
wherein relative positions of individual ones of the out-coupling sub-regions with respect to the diffractive in-coupling region of the optical waveguiding component are arranged so that each of the individual out-coupling sub-regions intercept light emitted by selected ones of the light emitting sources of the assembly of light emitting sources.

2. The waveguide-based light emitting module in accordance with claim 1, further comprising an optical element disposed between the out-coupling region and the region spatially separated from the waveguide-based light emitting module, wherein the optical element includes an additional diffractive structure.

3. The waveguide-based light emitting module in accordance with claim 1, wherein said optical waveguiding component includes a beam-splitting region that splits the in-coupled light into a plurality of fractions and directs said fractions onto the out-coupling sub-regions.

4. The waveguide-based light emitting module in accordance with claim 1, further comprising an actuation mechanism for positional adjustment of the light emitting sources with respect to the lens.

5. The waveguide-based light emitting module in accordance with claim 1, wherein diffraction properties, sub-wavelength structure topology, and/or azimuthal orientation of phase gradients of the out-coupling sub-regions are individually configured for out-coupling light from selected ones of the light emitting sources.

6. The waveguide-based light emitting module in accordance with claim 1, further comprising an image-forming display in proximity to the waveguide-based light emitting module, and wherein the out-coupled light is directed through partially transparent regions of the image-forming display.

7. The waveguide-based light emitting module in accordance with claim 6, wherein the lens is placed on a side of the optical waveguiding component opposing the image-forming display.

8. The waveguide-based light emitting module in accordance with claim 1, wherein the optical waveguiding component includes cladding layers.

9. The waveguide-based light emitting module in accordance with claim 1, wherein the optical waveguiding component includes reflective coatings applied to said optical waveguiding component, and wherein said reflective coatings contain at least partially transparent regions that include in-coupling and out-coupling regions.

10. The waveguide-based light emitting module in accordance with claim 1, further comprising at least one additional light-emitting source assembly each with an additional corresponding lens and an additional corresponding in-coupling region.

11. A waveguide-based sensing module for sensing incident light, comprising:
an optical waveguiding structure that includes an in-coupling region and an out-coupling region;
a lens structure positioned to capture out-coupled light field radiation from the out-coupling region of the optical waveguiding structure;
a photosensitive pixelated array located to receive the out-coupled light field radiation transformed by the lens structure and configured to convert the out-coupled light field radiation into electrical signals,
wherein the in-coupling region of the optical waveguiding structure includes a plurality of in-coupling sub-regions configured to diffract at least a fraction of in-coupled light incident from a particular region spatially separated from the in-coupling region, and
wherein at least some of the in-coupling sub-regions include diffractive structures with different diffractive properties from others of the in-coupling sub-regions.

12. The waveguide-based sensing module in accordance with claim 11, further comprising an image-forming display in proximity to the waveguide-based sensing module, and wherein the in-coupled light is directed through partially transparent regions of the image-forming display.

13. The waveguide-based sensing module in accordance with claim 11, wherein the in-coupling sub-regions include diffractive structures having an azimuthal orientation and a sub-wavelength topology with a periodicity that depends at least in part on relative positions of the in-coupling sub-regions with respect to the out-coupling region.

14. The waveguide-based sensing module in accordance with claim 11, wherein the out-coupling region of the waveguiding structure includes a diffractive structure.

15. The waveguide-based sensing module in accordance with claim 11, wherein a lateral size of the in-coupling region of the optical waveguiding structure is larger than a lateral size of the out-coupling region of the optical waveguiding structure.

16. The waveguide-based sensing module in accordance with claim 11, further comprising a diffractive component positioned to receive the incident light before being directed to the in-coupling sub-regions of the optical waveguiding component.

17. The waveguide-based sensing module in accordance with claim 11, further comprising an actuation mechanism for positional adjustments of the photosensitive pixelated array with respect to the lens.

18. The waveguide-based sensing module in accordance with claim 11, wherein the optical waveguiding component includes cladding layers.

19. The waveguide-based sensing module in accordance with claim 11, wherein the optical waveguiding component includes reflective coatings, and wherein said reflective coatings include at least partially transparent regions that include in-coupling and out-coupling regions.

20. The waveguide-based sensing module in accordance with claim 11, further comprising at least one additional photosensitive array each with an additional corresponding lens and an additional out-coupling region.
